(19) United States
(12) Patent Application Publication
(10) Pub. No.: US 2005/0055224 A1
(43) Pub. Date: Mar. 10, 2005

(54) System, method, and computer program product for managing interoperable data processing system services

(75) Inventors: Sanjay P. Lobo, Allen, TX (US); Richard G. Ramos, Plano, TX (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 10/654,868

(22) Filed: Sep. 4, 2003

(51) Int. Cl. G06F 17/60

(52) U.S. Cl. 705/1; 705/28; 705/10

(57) ABSTRACT

A system, method, and computer program product that enables a complete view of all system components, including system management, application management, and other system metrics. Further disclosed is the functional architecture for an Interoperable Service Management Platform (ISMP) that enables fulfillment, assurance, billing and business analytics of enterprise services, including but not limited to desktops, applications, and networks, in a utility-based model.

### TECHNICAL FIELD OF THE INVENTION

The present invention is directed, in general, to large-scale data processing system services management.

### BACKGROUND OF THE INVENTION

A data processing system deployments in large entities become more pervasive, it becomes increasingly important to be able to manage system services across the network in an efficient manner with a large-scale perspective.

Current methods for managing such system services include specific and independent interfaces and controls for each of many different aspects of the overall enterprise system. As a result, managing various aspects of the system is difficult, as the system manager or managers can only view one aspect of the deployment while making changes, without the ability to review and coordinate other aspects of the deployment.

There is, therefore, a need in the art for an improved system, method and computer program product for managing data processing system services.

### SUMMARY OF THE INVENTION

A preferred embodiment provides a system, method, and computer program product that enables a complete view of all system components, including system management, application management, and other system metrics. Further disclosed is the functional architecture for an Interoperable Service Management Platform (ISMP) that enables fulfillment, assurance, billing and business analytics of enterprise services, including but not limited to desktops, applications, and networks, in a utility-based model.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a data processing system network in accordance with a preferred embodiment;

FIG. 2 depicts a data processing system in accordance with a preferred embodiment;

FIG. 3 depicts a block diagram of the functional architecture of a system in accordance with the preferred embodiment; and

FIG. 4 depicts a flowchart of a process in accordance with a preferred embodiment of the present invention.

### DETAILED DESCRIPTION OF THE INVENTION

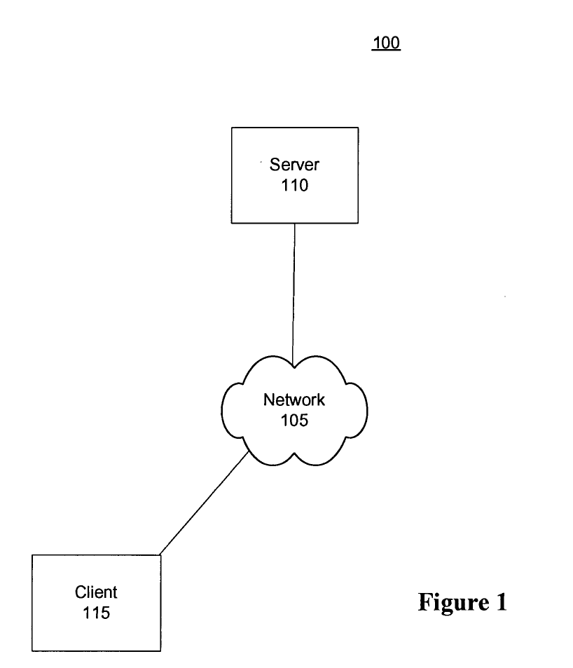

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A preferred embodiment provides a system, method, and computer program product that enables a complete view of all system components, including system management, application management, and other system metrics. Further disclosed is the functional architecture for an Interoperable Service Management Platform (ISMP) that enables fulfillment, assurance, billing and business analytics of enterprise services, including but not limited to desktops, applications, and networks, in a utility-based model.

Where particular commercial software packages or applications are noted herein, it is understood that these are exemplary applications suitable for particular implementations, and those of skill in the art will recognize that other commercial products or privately developed applications can also be used, provided they perform the functions described.

FIG. 1 depicts a block diagram of a data processing system in which a preferred embodiment can be implemented. Network system 100 can be implemented in any type of public or private computer network, and can be implemented by data processing systems connected by telephone line, a local-area-network, a wide-area-network, by Ethernet, fiber optic cable, or any other known means.

Server 110 is connected to network system 105, and can thereby communicate with client system 115.

Typically, a user will use client system 115 to access a servlet and data on server 110. The user will typically use a thin-client browser on client system 115 to access server 110. It should be noted that typically many other data processing systems will be connected to network system 105, including multiple client systems and multiple server systems.

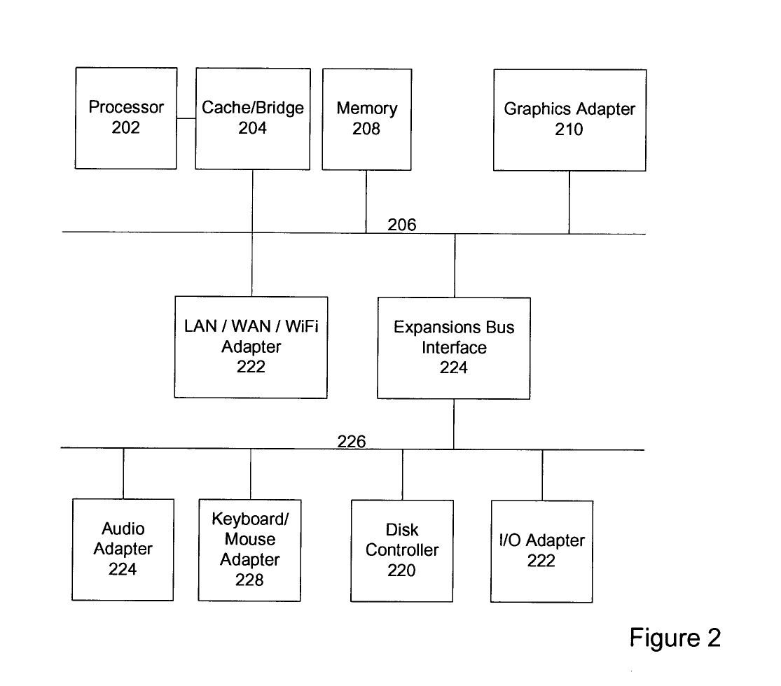

FIG. 2 depicts a data processing system in which a preferred embodiment of the present invention may be implemented, as any of the disclosed data processing systems. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 216 is connected to keyboard/mouse adapter 218, disk controller 220, and I/O adapter 222.

Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, etc.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

The ISMP provides a consolidated view of service delivery through a single web-based console. Some of the attributes of the ISMP include:
The autonomic detection and correction of critical faults thus providing self-healing management capabilities;
The assured redundancy and fault tolerance through automated workload redirection, data caching, mirroring, and synchronization, a fail-over and high availability solution that enterprise applications need;
A dynamic delivery of services that can be provisioned from a shared resource pool;
Customer and Service analytics to insure high level of service excellence and increased customer satisfaction; and
The platform is web services enabled to ensure interoperability and manageability over standards based protocols (SOAP, WSDL, WS-Security, etc.).

The ISMP solution can be implemented in either a hosted environment within an enterprise or as a managed hosted service that is provided by a hosting provider. The ISMP framework is orchestrated by several hardware and software components and provides scalable, reusable, and interoperability functions.

There are several stages for the implementation of the ISMP platform. They include setup of the infrastructure (installation and configuration of hardware and software), setup of the applications-on-demand and web services that are being made available for provisioning, account administrator setup (corporate/individual administration setup), account user setup (corporate/individual user setup), service provisioning, and lastly the account deactivation.

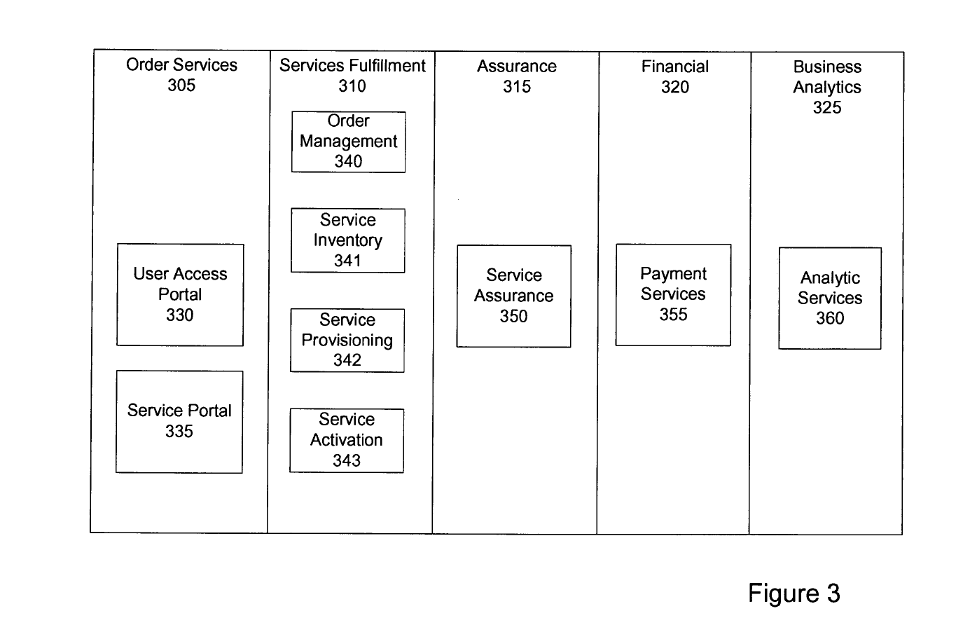

The overall functional architecture of the ISMP consists of five primary components. They are order entry, service fulfillment, assurance, billing and business analytics. Enterprise business process and workflow engines drive the ISMP framework. The ISMP framework and the associated processes have been illustrated in FIG. 3, and are described below.

Order Services 305 includes the User Access Portal 330 and the Service Portal 335. The user access portal 330 (UAP) is used as an entry point to setup corporate/user administrative accounts. The portal is available over the Internet or other network. The catalog of services is accessible via the UAP. The UAP provides personalization and search capabilities for the provisioned services. Several portal vendors (BEA, Sun, Microsoft, Vignette, and others) provide the infrastructure to build and manage the portal. The UAP 330 also includes authentication and access services.

A first time user can view the catalog of services but would need to register to request and use a service. The identity (including the user authentication and access rights) of the user is stored in an LDAP directory and can be leveraged from existing user profiles in other corporate directory servers. Based on the end-user credentials one could access different views. A corporate administrator can administer the access rights to the corporate users. In addition, the corporate administrator could delegate administrative rights to departments or user groups to setup users. In a non-corporate environment, the user registering for services could administrator his or her account. Integration with Identity Management Services such as SunOne Identity Management Services, and Microsoft NET Passport provide for a common XML framework for security defined by industry standards SAML (Security Assertion Markup Language).

The service portal 310 is accessible over the Internet or other network. The services portal 310 (SP) has three components—the catalog of services, a reporting dashboard for the user, and a reporting dashboard for the administrator. A catalog server is integrated with the portal server. The services listed in the catalog of services may include applications on demand, web services and other custom legacy-based applications.

Limited access to the service portal 310 is made available to the visitors. They can only view the catalog of services. The registered user will have access to the catalog as well as the management “dashboards.”

The administrative user can view all the services available in the catalog. The administrative dashboard provides for the management of the following: Subscriber Services; Customer Care; Order Status; Provisioning Status; Activation Status; Inventory Management; Security Management; and Online Documentation.

The non-administrative user can view the list of all the services subscribed by the administrator but may not have access to all these services as the user may have subscribed only to a subset of the services on this list. In addition, this user can use the user dashboard to manage the following: Current Services; Pending Requests; Billing Reports; Trouble Reporting; and Service Fulfillment.

The service fulfillment 310 is composed of the order management 340, service inventory 341, service provisioning 342, and service activation 343.

Order Management 340 is a key component of the ISMP platform that triggers a service request. It consists of a three-stage process—order entry, service inventory and the service request. A workflow management system is used to define, manage, execute and monitors workflows. Using an integration platform, the task of the data transformation from one application/service to the next is done via the reliable messaging component of this platform. The integration platform is coupled with workflow management.

Once the user has ordered services from the catalog of services via the order entry process the order is captured and discomposed in the appropriate format (standards based XML format) to be used by different components. BEA, ATG, Microsoft provide B2B/B2C commerce servers.

A check for the availability of that request for service is made through the service inventory 341 component. The service inventory 341 component (SIC) provides a service topology (Network Configuration, Applications/Keys, Server configuration, etc.) that is stored as metadata is a lightweight database. The differentiator of the SIC is the real-time access of aggregated inventory information of the functional provisioning components. High availability of the database server (such as Oracle) is important to provide and capture real-time information about systems and processes.

Following the service inventory check, the service request is formulated and triggers the request to the different domain managers (Application, Compute, Storage and Network) for the provisioning of the service requested.

Service Provisioning 342: The integration platform provides the activation sequence along with the management of the requests. These interface with the domain managers. There are separate domain managers for each of the domains. The domains include applications, compute, storage and network domains. Opsware Blade Edition automates operating system and application infrastructure provisioning. Digital Fairway has components that provision network domain, and other vendors do the provisioning for the storage domain. These domain managers have ISM (Intelligent Service Modules) that can be custom developed to provision and activate the service being requested. The transactions requested to and from these domains are captured and stored in the metadata database discussed above.

Service assurance 350 is a part of assurance 315 and plays a key role for ISMP once the service is activated and is being managed. Existing or custom probes using SNMP, XML or other standards protocols are built to monitor the different service domains for enterprise systems management (e.g., performance management, fault management, security managementm and customer relationship management). The SLA (Service Level Agreement) contracted with the end-user (customer) indicates the level of management to ensure level of service requested. Tools used for service assurance can include SMARTS, HP OpenView, Micromuse, and others.

Financial 320: As the service has been setup and is being managed, the payment services 355, including the metering and billing components of the ISMP platform, is activated. Metering solutions from vendors such as Ejacent track the required transaction needed for billing. This is fed into ADC SingleView to process the billing, volume rating, usage billing, costing, etc. This is then used by some ERP systems (SAP) to do the financial posting and invoicing.

Business Analytics 325: The ISMP is engaged in event collection process, which is used by analytic services 360 customer and system analytics. A CRM solution can provide and manage this information.

The customer analytics can include attributes such as customer demographics, customer industry sector, customer application subscription, usage of the application, etc., which could be used to suggest the current usage of the application(s), up-sell/cross-sell opportunities, decision to continue at the current service level, etc.

The system analytics provides more overall application usage, information of license brokerage (usage), type of customers (industry and other demographics) to make decisions to manage (increase or decrease) the level of services or maybe to add additional services.

There could be additional business intelligence focus area that could be applied to the data collected.

The preferred embodiments differ from known approaches in several ways. Although, there are solutions for each segmented silo of the services management platform that exists currently, there are no solutions that provide a collective view. Some particular benefits of the disclosed ISMP include the ability to order a diverse set of services using a single order management application. Further, the disclosed system provides a 360 degree view of entire customer service topology. Application, Compute, and Network Infrastructure interdependencies are captured and used to support the Assurance solution. Beyond that it provides the end user the ability of view and manage application, system and network metrics and other analytical information via a dashboard to meet the desired service-level-agreements and high-level of customer satisfaction at a reasonable price point.

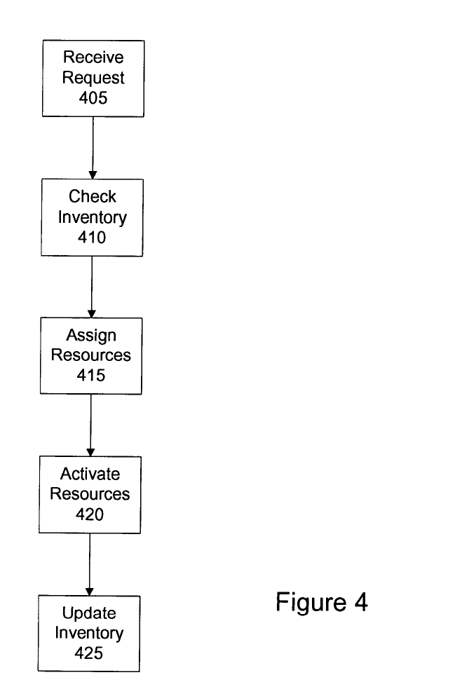

FIG. 4 depicts a flowchart of a process for automated system resources and services fulfillment in accordance with a preferred embodiment of the present invention. Here, the server system receives a request in its order management component for a system resource, such as additional hardware or software services, from a client system (step 405). This request can be made by a system user, customer, or by an automated process on the client or customer system.

Next, the system will check the resource inventory for the client system to determine if the requested system resource is available to the client system (step 410). It will do so, in the preferred embodiment, by accessing a metadata database that includes an inventory of hardware resources, such as additional servers, storage capacity, etc., and software resources such as available software application licenses and others. The inventory may also include references to other hardware and software resources that are not available to the client system for various reasons, including that they are not included in a customer service contract.

Next, the system will provision and assign available resources to the client, according to the request (step 415). The services will be automatically configured and activated as necessary, including configuring hardware, activating software licenses, applying appropriate access levels, etc., so as to make the requested resources available to the client system (to the extent they are available) (step 420).

The system will then update the inventory to indicate that the designated system resources have been assigned (step 425).

During this process, and before and after the process takes place, the ISMP system can display the current status of all requests, inventory, assigned hardware, and services, and can preferably display all of these concurrently.

The system uses a similar process to de-allocate system resources, and to return them to the inventory to be reassigned. In the preferred embodiment, the system can also determine that assigned system resources are not being utilized, and automatically de-allocate these.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A data processing server system connected to communicate over a network with at least one client data processing system, comprising:
an order services management component;
a services fulfillment management component;
an assurance management component;
a financial management component; and
a business analytics management component, wherein all components are simultaneously available to a user.

2. The data processing server system of claim 1, wherein a user of the server system can manage all aspects of services available to a user of the client system.

3. The data processing server system of claim 1, wherein the data processing server system is in a different location than multiple client data processing systems.

4. A method for system resource provisioning, comprising:
receiving a request from a user for a requested system resource;
checking a resource inventory to determine if a system resource that corresponds to the system resource is available to the user;
assigning a system resource, corresponding to the requested system resource, from the inventory to the user;
activating the system resource to be available to the user; and
updating the resource inventory to indicate that the system resource was assigned to the user.

5. The method of claim 5, wherein the system resource is a hardware resource.

6. The method of claim 5, wherein the system resource is a software resource.

7. The method of claim 5, further comprising configuring the system resource as required by the user.

8. The method of claim 5, wherein the status of all requests, inventories, and system services are simultaneously available to the user.

9. The method of claim 5, further comprising receiving a request to de-allocate an assigned system resource, de-allocating the assigned system resource from the user, and updating the resource inventory to indicate that the assigned system resource is no longer assigned to the user.

10. A computer program product tangibly embodied in a computer-readable medium, comprising:
instructions for receiving a request from a user for a requested system resource;
instructions for checking a resource inventory to determine if a system resource that corresponds to the system resource is available to the user;
instructions for assigning a system resource, corresponding to the requested system resource, from the inventory to the user;
instructions for activating the system resource to be available to the user; and
instructions for updating the resource inventory to indicate that the system resource was assigned to the user.

11. The computer program product of claim 10, wherein the system resource is a hardware resource.

12. The computer program product of claim 10, wherein the system resource is a software resource.

13. The computer program product of claim 10, further comprising instructions for configuring the system resource as required by the user.

14. The computer program product of claim 10, wherein the status of all requests, inventories, and system services are simultaneously available to the user.

15. The computer program product of claim 10, further comprising instructions for receiving a request to de-allocate an assigned system resource, instructions for de-allocating the assigned system resource from the user, and instructions for updating the resource inventory to indicate that the assigned system resource is no longer assigned to the user.

16. A data processing system having at least a processor and accessible memory, comprising:
means for receiving a request from a user for a requested system resource;
means for checking a resource inventory to determine if a system resource that corresponds to the system resource is available to the user;
means for assigning a system resource, corresponding to the requested system resource, from the inventory to the user;
means for activating the system resource to be available to the user; and
means for updating the resource inventory to indicate that the system resource was assigned to the user.

17. The data processing system of claim 16, wherein the system resource is a hardware resource.

18. The data processing system of claim 16, wherein the system resource is a software resource.

19. The data processing system of claim 16, further comprising means for configuring the system resource as required by the user.

20. The data processing system of claim 16, wherein the status of all requests, inventories, and system services are simultaneously available to the user.

21. The data processing system of claim 16, further comprising means for receiving a request to de-allocate an assigned system resource, means for de-allocating the assigned system resource from the user, and means for updating the resource inventory to indicate that the assigned system resource is no longer assigned to the user.
